(19) United States
(12) Patent Application Publication
(10) Pub. No.: US 2004/0148229 A1
(43) Pub. Date: Jul. 29, 2004

(54) Method and system for online software purchases

(76) Inventor: Scott Kevin Maxwell, Escondido, CA (US)

Correspondence Address: NIXON PEABODY, LLP, 401 9TH STREET, NW, SUITE 900, WASINGTON, DC, 20004-2128, US

(21) Appl. No.: 10/696,578

(22) Filed: Oct. 30, 2003

Related U.S. Application Data
(60) Provisional application No. 60/422,874, filed on Nov. 1, 2002.

(51) Int. Cl. G06F 17/60

(52) U.S. Cl. 705/26

(57) ABSTRACT

A system for purchasing software online includes a plug-in used by a software application on a computing device to enable software purchases offline. During a first time software purchase, the plug-in captures credit card, address, and e-mail informnation that is stored on the computing device. The software then is enabled, but the software purchase is pending until the computing device goes online to complete the pending transaction. For subsequent software purchases, when the computing device once again goes online, the subsequent pending transactions are processed. In other embodiments, distributor, software development tool provider, affiliate, and partner relationships with third parties are provided. In further embodiments, a coupon, up-selling, or special offer mechanism, an online software store, a site license server, a software developer's kit (SDK), including an application programming interface (API) are provided.

### CROSS REFERENCE TO RELATED DOCUMENTS

The present invention claims benefit of priority to commonly assigned, co-pending, U.S. Provisional Patent Application Serial No. 60/422,874 of Maxwell, entitled “METHHOD AND SYSTEM FOR ONLINE SOFTWARE PURCHASES,” filed Nov. 1, 2002, the entire disclosure of which is hereby incorporated by reference herein.

### BACKGROUND OF THE INVENTION

1. Field of the Invention

The present invention generally relates to software purchases, and more particularly to a method and system for online software purchases.

2. Discussion of the Background

Traditionally, online purchasing of software for computing devices, such as Palm Operating System (Palm OS) handheld devices, etc., has been a multi-step process fraught with error and confusion for the end-user. Many of these steps have conspired to create a barrier to online software purchases. As illustrated in the flowchart of FIGS. 5A-5C, the user typically must perform numerous steps before the online software purchase is completed.

For example, the user typically must be at a computer, which often is not the case when the user is using their handheld device away from work or home. The user must then figure out where to purchase the software online, enter their address and credit card information, and correctly enter their HotSync user name, for each purchase. However, many users do not end up purchasing a software product at this point, because they do not even know their HotSync user name or enter it incorrectly.

Assuming the user enters their HotSync user name correctly, the user must now correctly enter their e-mail address. If the user makes a mistake at this crucial step, there is no way for the online software vendor to contact the user. If, however, the user is able to make it this far in the online purchasing process, the user must now wait for an e-mail from the software vendor with a registration key for unlocking the software before the software can be used on the handheld device. The user must then enter the registration key into the software on the handheld device to enable the software. However, if there is a problem with the registration key, the user must now contact the software vendor and repeat many of the steps outlined above.

In addition, once a registration code has been sent to the user, a refund can be requested. However, if the software vendor grants the refund request, the user still has the registration code and cannot be prevented from continuing to use the returned application

### SUMMARY OF THE INVENTION

Therefore, there is a need for a method and system for online software purchases that address the above and other problems with the traditional approach, provide ease of purchasing software while offline, and do not require repetitive manual entry of user information.

The above and other needs are addressed by embodiments of the present invention, which provide a system for purchasing software online, including a plug-in used by a software application running on a computing device to enable software purchases, while the computing device is offline. While offline, during a first time software purchase, the plug-in captures user information, such as credit card, debit card or bank account information, address, and e-mail information, which is stored on the computing device. The user then clicks on a “Buy” button and the software is enabled, but the software purchase is pending until the computing device goes online and communicates with a service provider for the online software purchase system to complete the pending transaction. For subsequent software purchases, the user simply chooses a credit card, debit card or bank account, clicks on the “Buy” button, and when the computing device once again goes online, the computing device communicates with the online software purchase system to complete the subsequent pending transactions.

Advantageously, the user can be contacted by the online software purchase system to correct mis-entered information, to provide software updates, price updates, software upgrades, and purchasing incentives, when the computing device is online. In other embodiments, distributor, software development tool provider, affiliate, and partner relationships are established between the service provider and third parties. In further embodiments, a coupon, up-selling, special offer, etc., mechanism and an online software store are provided. In still further embodiments, a site license server and software developer's kit (SDK), including an application programming interface (API) are provided. In still further embodiments, a mechanism for returning purchased software is provided.

Accordingly, in one aspect, a system, method, and computer program product for purchasing software online is provided. The system, method, and computer program product includes enabling a software purchase transaction for a computing device, while the computing device is offline; and completing the software purchase transaction, when the computing device goes online.

In another aspect, a system, method, and computer program product for purchasing software online is provided. The system, method, and computer program product includes correcting mis-entered information relating to a software purchase for a computing device, while the computing device is offline; and communicating one of software updates, price updates, software upgrades, and purchasing incentives, when the computing device goes online. The system, method, and computer program product also can include minimizing the possibility of mis-entered information relating to a software purchase for a computing device, whether or not the computing device is offline or online.

In another aspect, a system, method, and computer program product for purchasing software online is provided. The system, method, and computer program product includes providing a software distributor relationship between a vendor and a software distributor; and enabling revenue distribution between the vendor and the software distributor for distributed software purchased on a computing device.

In another aspect, a system, method, and computer program product for purchasing software online is provided. The system, method, and computer program product includes providing a software development tool provider relationship between a vendor and a software development tool provider; and enabling revenue distribution between the vendor and the software development tool provider. The system, method, and computer program product also can include the development tools to be paid for out of product revenues instead of being purchased outright.

In another aspect, a system, method, and computer program product for purchasing software online is provided. The system, method, and computer program product includes providing a software affiliate relationship between a vendor and a software affiliate; and enabling revenue distribution between the vendor and the software affiliate for affiliate software purchased on a computing device.

In another aspect, a system, method, and computer program product for purchasing software online is provided. The system, method, and computer program product includes providing a software partner relationship between an online software purchase service provider and a software partner; and enabling revenue distribution between the online software purchase service provider and the software partner for partner software purchased on a computing device.

In another aspect, a system, method, and computer program product for purchasing software online is provided. The system, method, and computer program product includes providing site licenses for software purchased for computing devices; and distributing the site licenses to the computing devices.

In another aspect, a system, method, and computer program product for purchasing software online is provided. The system, method, and computer program product includes providing one of coupon, up-selling, and special offer mechanism for software purchased on a computing device; and distributing a coupon based on the mechanism to the computing device.

In another aspect, a system, method, and computer program product for purchasing software online is provided. The system, method, and computer program product includes developing software for purchase on a computing device, while the computing device is offline; and distributing the developed software to the computing device.

In another aspect, a system, method, and computer program product for purchasing software online is provided. The system, method, and computer program product includes providing an interface for application programming in software for purchase on a computing device, while the computing device is offline; and distributing the software to the computing device.

In another aspect, a system, method, and computer program product for purchasing software online is provided. The system, method, and computer program product includes distributing a single computing device site license for software purchased for a computing device; and activating the single device site license on a computing device that first requests activation of the single computing device site license.

In another aspect, a system, method, and computer program product for purchasing software online is provided. The system, method, and computer program product includes purchasing software for a computing device, while the computing device is offline; and accessing information for completing the purchase from the computing device when the computing device goes online, without storing the purchasing information external to the computing device.

In another aspect, a system, method, and computer program product for purchasing software online is provided. The system, method, and computer program product includes storing software registration keys for computing devices; and distributing the stored software registration keys to the computing devices online.

In another aspect, a system, method, and computer program product for purchasing software online is provided. The system, method, and computer program product includes prompting a user of the software to confirm a refund request from within the software; and disabling the software before sending a refund authorization to a service provider of the software.

In another aspect, a system, method, and computer program product for purchasing software online is provided. The system, method, and computer program product includes confirming a return of the purchased software; and deactivating the software, if the return is confirmed by a user of the software.

In another aspect, a system, method, and computer program product for purchasing software online is provided. The system, method, and computer program product includes providing a site license for software purchased for a computing device, wherein the site license is configured as a generic license for the software purchased for the computing device; converting the generic license to a device specific license for the computing device; and distributing the device specific license to the computing device.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is an exemplary online software purchase system, according to an exemplary embodiment;

FIGS. 2A and 2B are exemplary software and hardware components of the online software purchase system of FIG. 1;

FIGS. 3A and 3B are a flowchart of an exemplary online software purchase process, according to an exemplary embodiment;

FIG. 4 is an exemplary computer system, which may be programmed to perform one or more of the processes of the described embodiments; and

FIGS. 5A-5C are a flowchart of an online software purchase process, according to the background art.

### DETAILED DESCRIPTION OF THE PREFERRED EMBODIMENTS

Generally, the described embodiments provide a sales conduit for purchasing of software applications for computing devices, such as handheld devices (e.g., Palm OS handheld devices), personal digital assistants (PDAs), cell phones, personal computers (PCs), laptop computers, etc. The described embodiments allow users to purchase software applications directly on their computing devices.

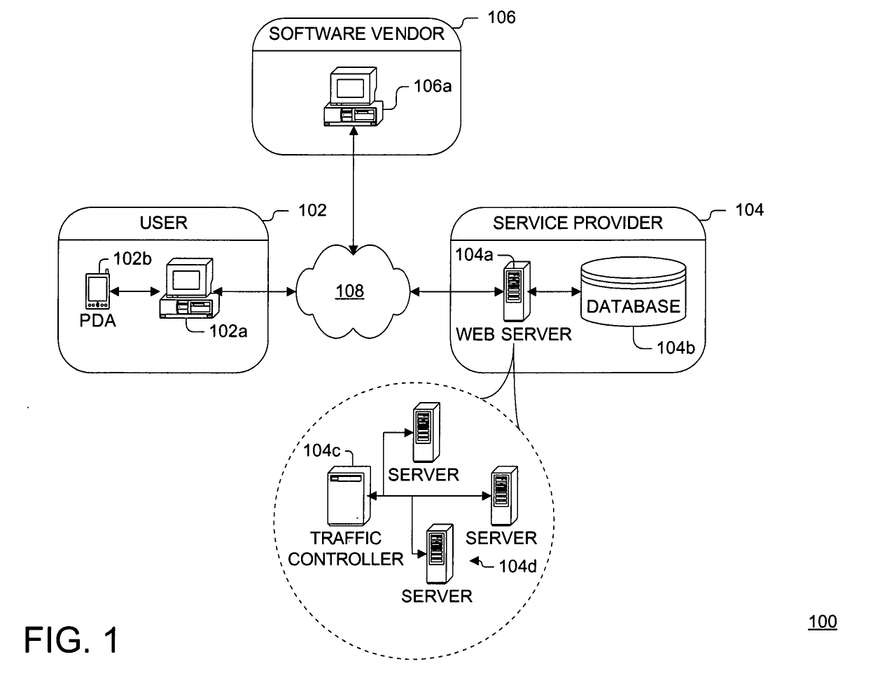

Referring now to the drawings, wherein like reference numerals designate identical or corresponding parts throughout the several views, and more particularly to FIG. 1 thereof, there is illustrated an online software purchase system 100, according to an exemplary embodiment. In FIG. 1, the online software purchase system 100 includes end user computing devices 102, such as a PC 102a and PDA 102b, service provider equipment 104, such as a web server 104a (e.g., traffic controller or load balancer 104c and one or more servers 104d) and service provider database 104b, and software vendor equipment 106, such as a PC 106a. The end user computing devices 102, service provider equipment 104, and software vendor equipment 106 can communicate with each other over a communications network 108, such as the Internet.

The various exemplary embodiments described below include, for example, various services, such as a handheld device-based software purchasing service, an Affiliate System, a Coupon and Special Offer System, a software store, and a site license server. The various features and services of the exemplary embodiments will now be described with reference to FIGS. 1-3.

The service provider database 104b can include, for example, an SQL database server to store various types of information including, for example, end user information, vendor information, software application information, credit card information, coupon records and information, etc. The web server 104a, for example, automatically tracks device and name changes for the end users to detect improper use of such information, provides an online software store accessible by the end users, maintains a record of software purchases made by the end users, etc.

Via the utility applications installed on the user computing devices as further described, the web server 104a can ensure that the end users are provided with the latest information, such as valid registration keys for purchased software applications, advertisements, product information, purchasing incentives, etc. Advantageously, the software vendors can use this feature, for example, to send coupons to owners of other software products. For example, if MyCalc 4.0 is released and includes upgrade incentive, a coupon for $10 off the purchase price can automatically be sent by the web server 104a to registered end users of MyCalc 3.0 and displayed within the application.

The software vendors are able to securely log on to the web server 104a at any time via a Web or other interface (e.g., a web browser, telephone, fax, e-mail, etc.), for example, to set up an account with the service provider, review purchase statistics, retrieve a list of registered users, handle returns, send complimentary registration keys, add to the list of offered software applications, modify software application descriptions, provide links for downloading the software applications, etc. The software vendors also can update the terms of the sales, company information, application name and price, etc. The updated information is automatically sent from the web server 104a to the end user computing devices 102 over the communications network 108, for example, when the end user performs a synchronization operation (e.g., a HotSync operation) between the end user PDA 102b and PC 102a.

For example, when the end user downloads from the web server 104a trial versions of software applications, the current pricing, product information, coupon or advertisement information, etc., for the software applications also are included with the download and are automatically stored by the utility applications on the user computing devices 102. Then, when the user performs a synchronization operation, any updated information is automatically sent from the web server 104a to the end user computing devices 102 over the communications network 108. Advantageously, the end user is automatically kept informed of the latest pricing, coupon information, etc., for the software applications and can purchase the software applications at any time via the end user PC 102a or PDA 102b.

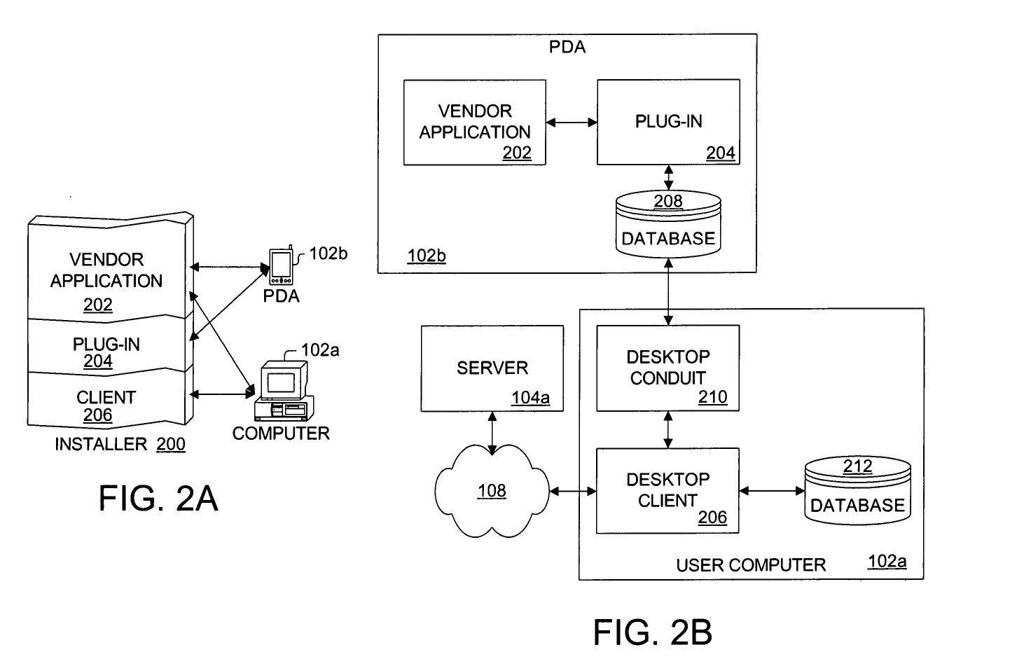

Software vendors can make simple modifications to their software applications to integrate with the online software purchase system 100. For example, as shown in FIG. 2A, the software application can be configured to include an installer 200 for installing the vendor's software application 202, a plug-in 204, and a desktop client or components 206. As shown in FIG. 2A, the vendor application 202 and plug-in 210 communicate with the end user PDA 102b and the vendor application 202 and the client 206 communicate with the end user PC 102a. As shown in FIG. 2B, the end user PDA 102b includes the vendor application 202, the plug-in 204, and a database 208 for storing the previously described information, the end user PC 102a includes a desktop conduit 210 (e.g., a cradle for performing HotSync operations), a database 212 for mirroring the PDA 102b database 208, and the desktop client 206 for communication with the web server 104a over the communications network 108.

Many software applications (e.g., for the Palm OS), however, may not require the installer 200, and, for example, easy to use, free installers for Windows, Macintosh, Linux, etc., operating systems can be provided by the web server 104a. The newest version of the plug-in 204 is provided on the end user PDA 102b, even if dozens of service provider enabled software applications 202 are installed. Then, when the software application 202 starts, the software application 202 attempts to load the plug-in 204. If the plug-in 204 loads successfully, the software application 202 can make simple calls to get a software registration state, retrieve a software registration key, etc., from the database 208, and execute a registration agent to allow the end user to purchase the software product. If the registration state is “pending,” because the end user credit card and other information has not been transferred to the web server 104a, the software application 202 still treats the software application 202 as having been purchased. The “pending” state can be maintained, for example, until the transaction is processed, the credit card is declined, a predetermined amount of time has expired (e.g., seven days), etc. For example, if the software purchase has been pending for over one week, a “pending too long” state is initiated and the software application 202 reverts to trial or expired mode or state.

In FIG. 2B, each vendor software application 202 includes a unique pair of identifiers (e.g., creatorID/editionID). One identifier (e.g., editionID) allows for identification of multiple versions of the same software application 202, such as a standard and a pro version, version 3.0 and version 4.0, etc. Alternatively, a unique product ID can be assigned to each version of the software application 202. The vendor application 202 passes basic information to the plug-in 204 to identify itself via terms (e.g., creatorID, editionID, distributorID terms) and a price for the software product. Alternatively, the vendor application 202 can store basic information in application resources that the plug-in 204 can read directly. The plug-in 204 passes to the vendor application 202 from the database 208, the registration state, a software registration key, if present, and the price. There is no need for the vendor application 202 to know anything else about the process.

Then, the plug-in 204 automatically handles further interaction with the end user. For example, when the plug-in 204 is loaded, the plug-in 204 checks for updates retrieved from the web server 104a over the communications network 108 via the desktop conduit 210 and client 206. If an update is found, the plug-in 204 prompts the user to see if the user wants to download the update at that time or at the next time the user synchronizes the PDA 102b with the PC 102a. The plug-in 204 also informs the end user of any coupons, advertisement, purchasing incentives, etc., provided by the software application 202 vendor. Advantageously, participating vendors can send coupons for various reasons, such as upgrades or seasonal offers. The user, however, can opt out from receiving information, such as coupon and purchasing incentive, etc., notifications from the software vendor. 1441 If the trial period has expired, the vendor application 202 can ask the user if they would like to purchase the vendor application 202 immediately. Then, if the end user wants to purchase the vendor application 202, the application 202 simply calls a Register( ) function. If the software purchase has been pending for a predetermined period of time (e.g., over one week), the end user is prompted by the plug-in 204 to perform a predetermined operation (e.g., a HotSync operation) to complete the software purchase.

If the application 202 calls the Register( ) function, the end user is presented by the plug-in 204 with an information screen of a user interface, for example, displaying the title of the software application 202, the price, qualified discounts, terms of the purchase, etc. The end user then simply selects or clicks on the “Buy” button displayed on the user interface to purchase the vendor's application software 202.

The end user then is prompted by the plug-in 204 for information used to complete the software purchase. For example, if this is the first time the end user has used the service provider service, the end user is prompted by the plug-in 204 for user information, such as user name, e-mail address, shipping address, etc.

If the end user has not yet entered credit card, debit card or bank account information or if the end user chooses to use new credit card, debit card or bank account information, the end user is prompted by the plug-in 204, for example, for the credit card type, number, expiration date, name on the card, billing address, a nickname for the credit card, a password, etc. For security purposes, the end user confidential information, such a credit card number, etc., is stored in an encrypted format so that once a credit card record is created, the credit card number can no longer be decrypted, for example, on the end user computing devices 102, such as the end user PDA 102b. Accordingly, the credit card record can be decrypted, for example, via a private key stored in the service provider database 104b. In addition, the password provided is used to create an encrypted purchase authorization block. Alternatively, if the user does not intend to use the credit card for additional purchases, a random password can be automatically generated by the plug-in 204. The end user is prompted by the plug-in 204 to enter as many credit card numbers and information as they please, and can selectively make software purchases based thereon.

If, however, the end user has previously entered a credit card, the end user can choose to use that credit card again for the current purchase. For security purposes, the end user will be prompted by the plug-in 204, for example, to enter the password previously set for the chosen credit card. That password is used to create an encrypted purchase authorization block. The purchase authorization block is created by combining productID with a secure hash of the encrypted credit card number with a secure hash of the password. The combined hashes are then encrypted so that such information can no longer be decrypted, for example, on the end user computing devices 102, such as the end user PDA 102b. Accordingly, the purchase authorization block can be decrypted, for example, via a private key stored in the service provider database 104b.

The end user then signs directly on the end user PDA 102b (e.g., using the PDA 102b stylus, etc.) to initiate the software purchase transaction. At this point the software application 202 is enabled and the transaction is in the pending state.

The above information is stored in the PDA 102b database 208 and when the user synchronizes (e.g., via a HotSync operation) the PDA 102b database 208 with the PC 102a desktop database 212 via the desktop conduit 210 (e.g., the PDA 102b cradle), the PC 102a desktop client 206 processes any changes that have been made to the PC 102a database 212. The pending software purchase requests then are forwarded to the web server 104a by the desktop client 206 over the communications network 108. The transaction results, any updates, update notifications, revised software application details (e.g., new prices, descriptions, etc.), coupons and incentives, etc., then are retrieved from the web server 104a by the desktop client 206 and stored on the PDA 102b and PC 102a databases 208 and 212.

Accordingly, the desktop client 206 starts by contacting, for example, the traffic controller 104c of the web server 104a. The traffic controller 104c then directs the desktop client 206 to one of the servers 104d that is least busy (e.g., performs load balancing). The desktop client 206 then communicates directly with the selected server. However, in case of a server failure, the desktop client 206 can again contact the traffic controller 104c to be directed to another server. The desktop client 206 then sends the updated and/or modified records, such as purchase and update requests, etc., stored on the PC 102a database 212 to the web server 104a.

In the case of pending software purchases, the web server 104a attempts to process the credit card information supplied by the end user for the software purchases. If the pending transactions are approved, the web server 104a, for example, changes the registration states to “registered” and generates personalized registration keys for the purchased software applications, etc. At this time the web server 104a also sends any updated information, any requested software updates, etc., to the end user PC 102a via the desktop client 206. Such information is stored on the desktop database 212 and is synchronized with the mirrored database 208 on the end user PDA 102b, for example, immediately or upon a subsequent synchronization operation.

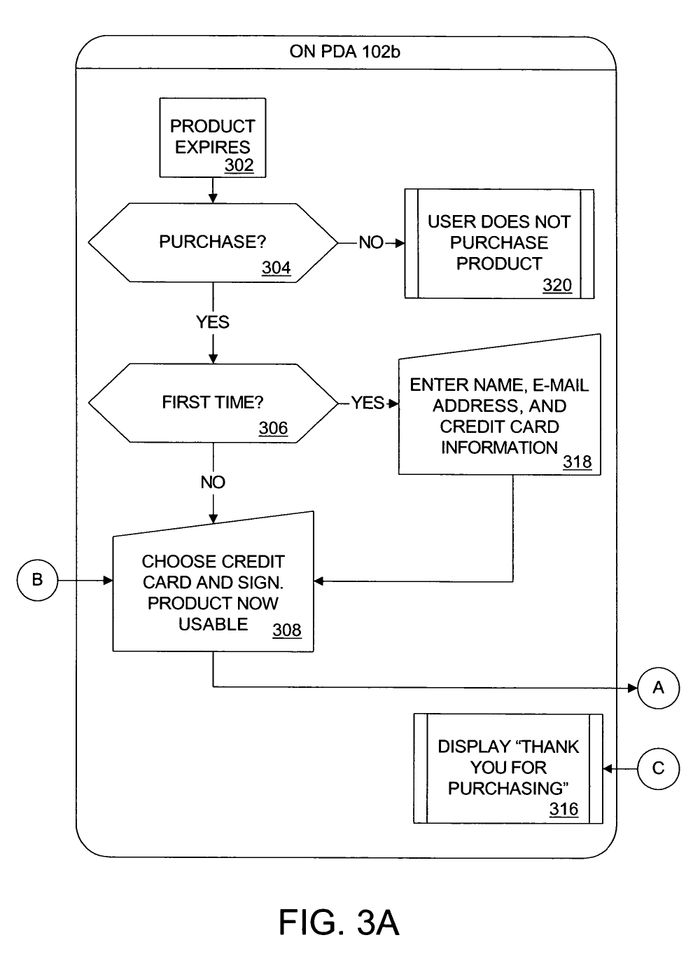

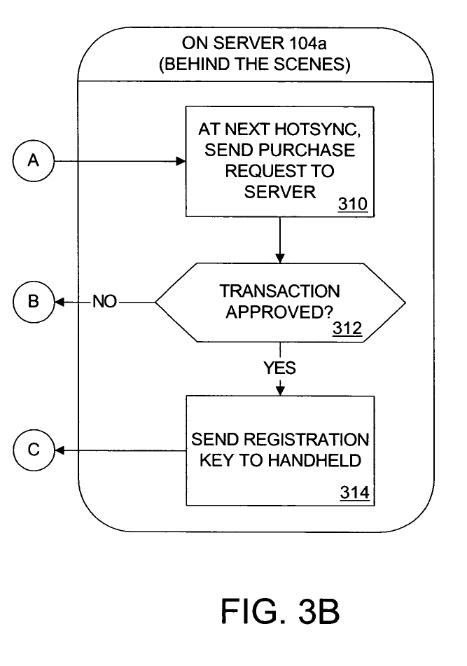

FIGS. 3A and 3B are a flowchart of an exemplary online software purchase process, according to an exemplary embodiment. The process of FIGS. 3A and 3B provides a means of purchasing software applications 202 directly from the end user handheld device, such as the end user PDA 102b. For example, suppose that an end user, named John, wishes to try, and then purchase a software application 202, Z Budget, a Palm OS budgeting application. The Z Budget application has been enhanced by the software manufacturer or vendor to use the service provider service, as previously described. As shown in FIGS. 3A and 3B, a typical user experience can include John downloading from the web server 104a the Z Budget application and installing the Z Budget application. Along with Z Budget application, the plug-in 204 and the desktop components 206 (e.g., the desktop client) are downloaded and installed, if necessary. 1541 Then, when John synchronizes his handheld device with his PC 102a desktop, the web server 104a is automatically checked for coupons, price changes, etc. John then tries the Z Budget application, which, for example, allows for the entry of up to 100 transactions before the application expires. When the application expires (step 302), John is prompted to buy the application (step 304) and agrees to do so. This may occur when John is in a store, using the application, and away from his PC 102a.

The plug-in 204 then takes over and uses a simple interview or prompting process (step 306) to acquire needed information from John, such as name, address, credit card data, etc. (step 318). Advantageously, step 306 performed if John has not previously purchased a software application from the service provider. John then clicks on the “Buy” button and is prompted to sign his name (step 308). John now owns the application, even though the credit card has not been processed. Internally this is stored as a pending transaction. John, however, may use the software application without limitation for a predetermined period of time (e.g., seven days) before finalizing the pending transaction.

Then, the next time John synchronizes his handheld with the PC 102a desktop (step 310), the pending transaction is (and, e.g., other pending transactions are) sent to the web server 104a for processing (step 312). The web server 104a then processes the credit card, generates a valid software registration code or key for the Z Budget application, for example, based on John's “HotSync user name,” and sends this information to the handheld device via the PC 102a client 206 and the desktop conduit 210 (step 314). A suitable message is generated (step 316) and John is now fully registered and, advantageously, with minimal user input.

Advantageously, most of the processing steps occur behind the scenes. For example, from John's perspective, the purchasing and registration process merely consisted of the prompting process followed by clicking on the “Buy” button. Then, if and when John purchases a subsequent application, John merely clicks on the “Buy” button (and optionally selects a credit card), since the other information to complete the transaction has been previously collected and stored on the PDA 102b and PC 102a database. The software purchase, advantageously, can be accomplished typically in less than 10 seconds and can occur in a store, on a plane, in line at an amusement park, in a restaurant, in Tokyo, etc.

In addition to simplified software purchases, the exemplary embodiments further include, for example:

Automatic updates: The end user is notified when an update is available and can request that the update be installed at next synchronization operation.

Registration key storage: The software registration keys for the purchased software applications are stored on the databases 208 and 212 on the end user computing devices 102 and on the database 104b on the web server 104a. Accordingly, if John should lose his handheld device 102b or if his PC 102a is disabled, the software keys can be retrieved from his account on the web server 104a at any time.

Name change service: If the end user should change names, for example, due to marriage or purchase of a new handheld device 102b, etc., the web server 104a can issue new software keys for previously purchased software applications 202. Advantageously, there is no need to contact each software vendor individually.

Foreign language support: The plug-in 204 automatically detects the language settings of the end user's computing devices 102. If language files are available for any software applications 202, they are automatically downloaded from the web server 104a.

Foreign currency support: The plug-in 204 automatically detects the country settings of the end user's computing devices 102. Optionally, software applications 202 can offer localized pricing. In this case, the vendor simply specifies the localized prices at the web server 104a and these are downloaded to the end user's computing devices 102 from the web server 104a. Advantageously, this allows the software vendors to offer lower prices in less prosperous countries.

In another embodiment, confidential information of the end user, such as the end user credit card information, name and address, etc., is not stored on the service provider database 104b, but rather on the databases 208 and 212 of the end user computing devices 102. The service provider then collects the end user confidential information when the end user computing device 102 (e.g., the end user Palm OS PDA 102b) connects to the web server 104a (e.g., during a HotSync operation). Advantageously, the service provider does not have to store the end user confidential information, resulting in increased security and satisfying jurisdictions that require that end user confidential information not be stored on the web server 104a for longer than a predetermined period of time (e.g., 2-3 days).

The service provider allows the software vendors to build affiliate programs with virtually zero effort. The service provider handles bookkeeping, advantageously, reducing back-office infrastructure on the part of the software vendor. Not only does this allow larger software vendors to outsource a low-profit earning piece of their business, this also allows smaller software vendors the opportunity to sell their software with minimal infrastructures and systems. The software vendors also can select from various types of business arrangements with the service provider, such as Software Distributors, Software Development Tools Provider, Affiliates, Partners, etc.

Distributors can include, for example, major web portals, such as PalmGear, Handango, Download.com, etc., stores, such as CompUSA, OfficeDepot, etc., hardware vendors, such as Sony, Palm, Toshiba, etc., that include a bonus software disk with their hardware, book and magazine publishers that distribute trial software CDs, etc. Each distributor can sign-up with the service provider and receives a unique distributor ID. A distributor ID can be included with the software product so that the software vendors can simply make a separate installer 200 for each distributor. Distributors can specify any percentage of the revenue that they wish. That percentage of the revenue is then diverted to the distributor at the time of the software sale.

For example, if Sony agrees to include a trial version of Product Z on their bonus disk, Sony can request the software vendor of that product to incorporate the service provider utilities and specify the Sony distributor ID. Sony might then specify a 20% revenue share. Accordingly, when a user installs Product Z from the Sony bonus disk and completes the sale through the service provider, Sony automatically receives 20% of the sale.

With respect to Software Development Tools Provider, the present invention recognizes that many software development tools are expensive for individual software developers, while at the same time serve a limited market. The result is that the software tools vendors often price their products too high for small developers to afford. A good example of this is the market for Macintosh installers. These products generally cost between $2000 and $5000 per year. Similar to the distributor mechanism described above, tool vendors may agree to allow the developer to use their tool for free in exchange for a per unit royalty. Normally this would be impossible for the tool vendor to manage or enforce. With the service provider, however, the process becomes automatic. Developers could use the Macintosh installer for no up front cost and the tool vendor would receive the amount they specify. This would normally be a fixed price, such as 50 cents or $1.

The Affiliates mechanism is similar to the distributor mechanism, except that the software vendors can be specified as an affiliate for a product. Whereas with distributors and tools vendors, the revenue share can be the same for all products, with affiliates, the revenue share can be specified on a per product basis. The affiliates system can be used to create any type of affiliate program that is required. For instance, Handmark might make a deal with Homework.com so that students can download the Handmark “4.0 Student” product from the Homework.com site. If the student decides to purchase the product, Homework.com can automatically receive a portion of the revenue. This can also be used for cross-selling between vendors. A company that sells an office suite could allow users to download another company's dictionary product from their site in exchange for a revenue share with the dictionary vendor. As with the distributor and tools vendor mechanisms, the vendor can create a custom version of their installer that includes the affiliate ID.

Partners can be specified for each product and get paid if a copy of that product is sold. This is most useful for situations, such as paying a royalty to a software developer or a technology licensor. For instance, Handmark distributes products developed by external programming houses and pays them a royalty. Using the Partners mechanism, the service provider can automatically pay the development team the agreed upon royalty. This royalty could be either a fixed amount or a percentage of the profits. Profits then are calculated as sales price minus all fees and other revenue shares. This could also be used to pay licensing fees for products with major brand names attached, such as the Zagat Restaurant Guide.

Coupons can be used to offer seasonal promotions, preferred customer discounts, student discounts, etc. The software vendors simply create a coupon on the service provider website and the coupon is sent to all relevant trial end users the next time the user connects to the web server 104a. The end users then are informed of the coupon the next time the vendor's software application 202 is executed after the start date of the coupon. After the end date of the coupon, the coupon will automatically be removed.

Upgrades are similar to coupons, except that they can be sent to end users who already own a software product. The upgrades can be used both for offering discounts on later versions of an already purchased software product and for doing cross-promotional offers for other software products. For example, Z Co. has been selling Product Z 1.0 for $19.95 for a year and has finally completed Product Z 2.0. The new version offers better performance and amazing new capabilities. Z Co. would like to charge an $8 upgrade fee to all existing users to recoup some of the development costs.

Without the service provider, however, Z Co. would need to send an e-mail to all of their customers. Many of the e-mail addresses would no longer be valid. Customers who wish to upgrade would then visit zco.com, enter proof of purchase, name, address, credit card, etc., and wait for an e-mail to arrive with a new key for Product Z 2.0. Many users will not want to go through this hassle just to pay an $8 upgrade fee and will simply stick with the old version (increasing support costs) or abandon the product altogether. For this reason, most handheld software vendors do not attempt to charge for upgrades at this time.

Using the service provider, however, the end user simply receives a message on their handheld device when they next use the Product Z 1.0. The handheld, for example, displays, for example, “Z Co. is proud to announce the release of Product Z 2.0. As an existing user, you are entitled to upgrade for only $8. Would you like to download and install the new version next time you HotSync?” The end user then clicks on a “Yes” button displayed and performs the HotSync operation. The latest version of the software then is automatically installed and the end user can try it for a predetermined period of time before deciding to upgrade. When the trial is up, the end user can purchase the upgrade for $8 by simply hitting the “Buy” button and signing their name, advantageously, resulting in no inconvenience and no interruption in use of the software product for the end user.

An example of using the upgrade mechanism for cross promotion, assumes Z Co. has a best selling game called Z Blaster and they have just released a new game called Z Cell. In order to increase awareness of the new title, they wish to offer a $5 discount to all of their Z Blaster end users. Without the service provider, however, Z Co. would need to send an e-mail to all of their end users. Many of the e-mail addresses would no longer be valid. Accordingly, end users who are interested in the new product would have to purchase through a special page on zco.com or use some kind of coupon code. Z Co. is only able to make this kind of offer because they have the back-end infrastructure to handle coupons or multiple prices.

With the service provider, however, current Z Blaster end users can receive a message the next time they play that game that says, for example, “Z Co. is proud to announce the release of Z Cell. As a registered Z Blaster user, you are entitled to purchase Z Cell for only $10, $5 off the retail price. Would you like to download and install Z Cell next time you HotSync?” The end user then clicks on a displayed “Yes” button and performs the HotSync operation. The new game then is automatically installed and the end user can try it for a predetermined period of time before deciding to buy the game. When the trial is up, they end user can purchase the title for $10 by simply hitting the “Buy” button and signing their name.

If the end user purchases Z Blaster while the discount offer is in effect, their experience will be only slightly different than described above. In this case, once the end user credit card clears and the end user receives a valid key for Z Blaster, the end user receives a message that says, for example, “Thank you for purchasing Z Blaster. As a registered user, you are entitled to purchase Z Cell for only $10, $5 off the retail price. Would you like to download and install Z Cell next time you HotSync?”

This cross promotional approach also can be used to offer discounts for software products of another company. This can be combined with the Affiliate System to create some very powerful cross-selling opportunities. For example, assuming Z Co. has an office suite called Z Office and D Co. has a dictionary called D Dictionary. In this case, when the end user purchases Z Office, the end user automatically receives a message that says, for example, “Thank you for purchasing Z Office. As a registered user, we have arranged for you to receive a $10 discount off of D Dictionary by D Co. Would you like to download and install D Dictionary next time you HotSync?” If the end user then clicks on a “Yes” button, a special Z Office version of D Dictionary is installed on next HotSync operation that includes the Z Co. affiliate ID. If the user then purchases D Dictionary, Z Co. receives 20% of the sale.

A Site License Server of the service provider is provided and designed to facilitate the purchase of software applications in bulk. For example, if IBM wants to purchase 100 copies of WordSmith, the IBM employee with purchasing authority purchases a 100-user site license for WordSmith from the service provider web site and receives a key file. The IBM information technology (IT) department then installs WordSmith and the key file onto each handheld device 102b. When each handheld device 102b is synchronized with the PC 102a desktop, the used key is sent to the web server 104a. The web server 104a then decrements the “unused” key count for the key file.

If the key is still valid, the web server 104a sends a “HotSync user name,” based registration code to the handheld device 102b. If, however, the key is no longer valid because it has been used on more than 100 different handhelds 102b, WordSmith remains locked on that handheld device 102b. An “Expired key” message then is displayed on the handheld device 102b and an e-mail is sent to the IBM purchasing authority. At this point, IBM may either renew the key by purchasing additional copies or retire WordSmith from handheld devices 102b that no longer require the software, freeing up copies for other users.

The service provider Site License Server can be part of a standard service offering provided to participating software vendors. The Site License Server also can operate as a standalone server that can be licensed to other companies. Large companies, such as Symbol, need a way to securely sell copy-protected software in bulk to end customers. The current solution is simply to sell the customer a key that will unlock an unlimited number of copies, with the hope that end users will not abuse this trust.

In another embodiment, the service provider and/or standalone Site License Server can be configured to distribute a single device or copy site license for a software product. The Site License Server then activates the site license for the first end user computing device 102 that connects to the web server 104a to activate the license. For end user handheld devices 120b (e.g., Palm OS PDAs), advantageously, the single copy site license can be distributed with no knowledge of the user name (e.g., Hotsync user name) of the end user. In this way, software products could be bought by third parties and distributed to end users, for example, as gifts, as part of product promotions, in raffles, etc. By contrast, traditionally, the user name (e.g., Hotsync user name) of the end user is required in order for a third party to purchase software for the handheld device 102b (e.g., Palm OS PDAs) of the end user.

As described above, the online software purchase system 100 provides a conduit for sales and promotions of software applications 202 for the end user computing devices 102, such as the end user PDA 102b and/or PC 102a. The online software purchase system 100 allows the end users the ability to purchase software applications 202, for example, directly on their handheld devices 102b, such as Palm OS handheld devices. The following sections describe how the software developers can incorporate functionality into their software applications 202 so as to integrate with the online software purchase system 100.

The software code for adding service provider functionality to the software applications 202 of software developers is available in the form of a service provider Software Developer's Kit (SDK). The SDK can be retrieved by the software developer, for example, in compressed (e.g., Zip) format via a web link provided on the web server 104a (e.g., serviceprovider.com/SDK.zip). The software developer then can extract the SDK into a main software project directory.

The software vendor adds the following files to their main project, for example:

PocketPurchaseClient.lib: Code for loading the plug-in 204.

PocketPurchaseClient.h: Glue code for interacting with the plug-in 204.

In further exemplary embodiments, PocketPurchasePluginBase.h: base code not used directly by the software vendors application 202, and PocketPurchaseResources.r: resource definitions for service provider resources (e.g., an .rcp file can be provided for GCC users) can be employed.

The following Application Programming Interface (API) calls can be employed to provide software functionally with the online software purchase system 100, for example:

```
    PocketPurchasePlugin*  PPurLoad(UInt32  regSeconds,  bool plug-in  Validated,
PocketPurchaseDigest* digest=0, bool silent=false);
    bool Valid( ) const;
    bool Register( );
    PPNagResponse DayNag(Int32 days);
    PPNagResponse UseNag(Int32 uses);
    PPNagResponse RecordNag(Int32 records);
    PPNagResponse TransactionNag(Int32 transactions);
    PPNagResponse CustomNag(const char *text);
    PPRegState GetRegState(char* buffer=0, Uint16* size, bool silent=false);
    void NotifyBadKey( );
    void SetExternallyRegistered( );
    void SetExpired( );
    void GetPrice(char* buffer);
    void SetAppData(UInt32 appData);
    UInt32 GetAppData( );
    bool ValidateKey(char* regCode);
    PPRegState DoPocketPurchase(UInt32 productID, UInt16 days, UInt16 uses, Boolean
trackInPocketPurchase, char* buffer, UInt16* size);
```

The following exemplary resources can be added to the vendor's software application 202 and can be updated with newer settings from the web server 104a, with some resources being optional:

‘PNam’-Name-String. Specifies the name of the software product 202.

‘PPub’-Publisher-String. Specifies the software developer's publisher name.

‘PPri’-Price-Signed string. The price of the application 202. Price strings are signed for security on the web server 104a.

‘PPSc’-Phone Surcharge-Optional signed string. Specifies a phone surchargefor taking advantage of “sell-by-phone” support by the service provider. Phone surcharge strings are signed for security on the web server 104a.

‘PTer’-Terms-String. Specifies the licensing terms, such as “Purchase includes free upgrades until the release of MyApp 2.0.”

‘PPID’-productID-A 32-bit value. This is the unique number used to identify the application 202.

‘PVID’-variantID-Optional 32-bit value. The variant ID may be used by the application vendor to indicate a minor variation of the same product. For example, the application vendor might wish to test slightly different trial mechanisms to ascertain which mechanism results in higher sales.

‘PCID’-creatorID-Optional 32-bit value. The creator ID of the application 202 is used by default. This value is specified if the application 202 is to use a different creator ID, such as when the current application 202 is a component of a larger application suite.

‘PEID’-editionID-Optional 16-bit value. Zero can be used if not specified. A separate entry can be created for each creatorID/editionID pair. The editionID can be used to differentiate full and light editions of an application 202 or for specifying paid upgrades. For example, MyApp 1.0 might not specify an editionID, but MyApp 2.0 could specify an editionID of 1, indicating that the application 202 is to be treated as a separate product.

‘PDID’-distributorID-Optional 32-bit value. Zero can be used if not specified. The distributorID can be used to indicate that a revenue share has been established with a publisher. A percentage of the price (that is specified) then is automatically sent to the indicated distributor.

‘PAID’-affiliateID-Optional 16-bit value. The affiliateID can be used to indicate that a revenue share has been established with an affiliate. A percentage of the price (e.g., that is specified) then is automatically sent to the indicated affiliate.

‘PTID’-toolID-Optional 32-bit value. The toolID can be used to indicate that a revenue share has been established with a tool provider. A percentage of the price (e.g., that is specified) then is automatically sent to the indicated tool provider.

PocketPurchasePlugin* PPurLoad(UInt32 regSeconds, bool plug-in Validated, PocketPurchaseDigest* digest=0, bool silent=false)

In an exemplary embodiment, a PocketPurchasePlugin object is instantiated once as a global object soon after the application starts. In a further exemplary embodiment, such objects are instantiated in the StartApplication function to check for updates and store the registration state, and before calling the Register( ) function.

The UInt32 regSeconds parameter specifies the time that the user first registered the application 202 through the service provider. Zero can be specified, but this parameter does provide some extra security against cheating. The intention is that the application 202 stores the result of TimGetSecond( ) somewhere in the preferences the first time the GetRegState( ) function returns ppRegPending. The results can be stored if they have never been stored in the past. The easiest way to do this is to initialize the location in the preferences to zero and only store TimGetSecond( ) if the current value is still zero.

The danger in not doing this is that the user could use a tool, such as Insider, to delete the record for the application 202 directly from the PDA 102b database 208. That would allow the hacker to register, not synchronize, wait until the application 202 has been pending too long, delete the record, and register again. By storing the time externally to the service provider, the hacking problem can be prevented.

The bool plug-in Validated parameter indicates whether or not the plug-in 204 has been validated. The plug-ins 204 are digitally signed to guarantee authenticity. Without this precaution, however, a hacker could install a false plug-in 204 that would report all software 202 as being registered in the “pending” state. Also, it would be possible for a rogue plug-in 204/conduit 210 pair to act as a Trojan horse, asking for the end user's credit card information and sending the data to a fake web server 104a. If the application 202 is already registered, neither of these is really a concern so the validation can be skipped. This is desirable since on a 33 Mhz device, the digital signature check can take ⅔ of a second.

The Digest* digest=0 parameter is a pointer to a 32-byte buffer to use for capturing the end user signature. If the software vendor stores this 32-byte signature, the ⅔ of a second check can be reduced to ⅓ of a second.

The bool silent=false parameter is used to prevent the constructor from displaying user interface elements to the end user. This should almost always be set to false.

Below is an exemplary code snippet employing the StartApplication function:

struct PPPrefs {

| | |
|---|---|
| PocketPurchaseDigest digest; | /* Storage for digital signature */ |
| UInt32 purchaseTime; | /* Store the registration time */ |
| } ppPrefs; | |
| ppPrefs.purchaseTime=0; | /* Initialize this to zero */ |

```
UInt16 pppSize=sizeof(ppPrefs);
/* Get the stored copy if it exists. Otherwise purchaseTime is already */
/* set to a good default and digest can contain random data. */
PrefGetAppPreferences (creatorID, ‘PP’, &ppPrefs, &pppSize, false);
/* Instantiate the plug-in if valid. We skip the digital signature check if the */
/* application is already registered. */
pocketPurchase = PPurLoad(ppPrefs.purchaseTime,prefs.isRegistered,&ppPrefs.digest);
/* Store the registration state in a global. */
/* If this returns ‘ppInvalid’, we know that the plug-in is either */
/* not present or not valid so we can skip all further PocketPurchase */
/* related code. */
g_ppRegState = pocketPurchase->GetRegState( );
/* Only do this if the plug-in is valid */
if (g_ppRegState != ppInvalid) {
  /* If the app is not registered... */
  if (prefs.isRegistered == 0) {
    /* If this is the first time we have seen ‘ppRegPending’, */
    if (g_ppRegState == ppRegPending && ppPrefs.purchaseTime == 0) {
      /* store it in our structure to prevent hacking of the */
      /* of the PocketPurchase database. */
      ppPrefs.purchaseTime = TimGetSeconds( );
    }
    /* Write the digest and purchase time to an unsaved pref */
    PrefSetAppPreferences(creatorID, ‘PP’, 0, &ppPrefs, sizeof(ppPrefs), false);
    /* If it is registered, call our function to validate the reg code */
    if (g_ppRegState == ppRegRegistered)
      CheckPocketPurchaseKey(pocketPurchase);
  /* Be sure to check for ‘ppRegCancelled’ */
  /* This allows PocketPurchase to deregister apps if it detects */
  /* cheating or if the user cancelled their order */
  } else if (g_ppRegState == ppRegCancelled) {
    prefs.isRegisterd = 0;
  }
}
```

The application vendor is advised not to used the above code snippet in its exact form for security purposes. If all applications 202 stored the digest in unsaved preference ‘PP’, it would be trivial for a hacking application to modify the preferences to allow a false plug-in 204 to run. This information can be stored, for example, (1) in the primary preferences, (2) in a feature, (3) in the AppInfo of a database, (4) in a data record, or (5) in it's own database.

Below is an exemplary code snippet employing the Register( ) function:

```
/* Only run PocketPurchase code if the plug-in was valid */
/* the first time we tried to load it. */
if (g_ppRegState != ppInvalid) {
  pocketPurchase->Register( );
  g_ppRegState = pocketPurchase->GetRegState( );
  ... additional code to handle the new registration state ...
}
```

If this is the first time the application 202 has been run, the plug-in 204 automatically creates a record for the application 202 using the previously described resources. The next time the end user performs a HotSync operation, the end user PC 102a desktop conduit 210 connects to the web server 104a and checks for any changes. In this way, the price, publisher name, etc., can be updated at any time.

Under certain circumstances, PPurLoad can interact with the end user. For example, if there are updates or coupons available for the application 202 and the end user has elected to receive update notices, the update notice is displayed during processing of the constructor. If the constructor is to be employed in situations where displaying user interface would be problematic, such as processing system find launch codes, etc., the silent parameter can be specified as true. Otherwise, false should be passed.

bool Valid( ) const

Checking of either the Valid function or for GetRegState( ) !=ppInvalid before using the plug-in 204 should be performed. The Valid function may return false, for example, if the plug-in 204 is not installed, the plug-in 204 is not valid, for example, if the digital signature verification failed, or the PDA 102b database 208 has not been initialized. The database 208 initialization is performed by the PC 102a desktop conduit 210. If, however, the end user does not have the PC 102a desktop conduit 210 installed, the pending transactions are not processed and are automatically deactivated.

bool Register( )

When the Register( ) function is called by the application 202, the function takes over and retrieves information from the end user used for purchasing the application 202. The Register( ) function returns true, if the pending transaction is completed.

```
        PPNagResponse DayNag(Int32 days)
        PPNagResponse UseNag(Int32 uses)
    PPNagResponse RecordNag(Int32 records)
PPNagResponse TransactionNag(Int32 transactions)
    PPNagResponse CustomNag(const char *text)
```

When the Nag( ) functions are called by the application 202, the plug-in 204 determines whether or not the application 202 has been purchased or not. If not, a custom, day, usage, record or transaction based trial dialog is displayed to the user and the user is given an opportunity to purchase the application 202. The Nag( ) functions return either ppurTry or ppurBuy.

PPRegState GetRegState(char* buffer=0, Uint16* size, bool silent=false)

The GetRegState function, for example, gets the registration state of the application 202, and if the application 202 has been registered and buffer is not NULL, the GetRegState function puts the key in the provided buffer. The size variable is used to indicate the size of the buffer.

The PPRegState parameter is an enum with the following values, for example:

ppRegNotRegistered—The application 202 is still in the trial mode.

ppRegPending—The end user has gone through the purchase process, but the transaction has not yet been sent to the PC 102a desktop for processing. This application 202 should be treated as registered, if this code is received.

ppRegPendingTooLong—The end user has gone through the purchase process, but the transaction has not yet been sent to the PC 102a desktop for processing. If silent is false, the GetRegState function displays an alert to the end user.

ppRegSentToDesktop—The purchase has been sent to the PC 102a desktop, but has not yet been sent to the web server 104a for processing.

ppRegCCProcessed—This code should not be received, unless the software developer or vendor has an Enterprise Key Server on their own server. In this case, ppRegCCProcessed would indicate that the credit card transaction has cleared, but the web server 104a has not been able to retrieve a key from the software developer or vendor Key Server. It is up to the software developer or vendor to know how to handle this situation, but it is recommend that the end user be given a relatively long grace period in this case. If the software developer or vendor does not use an Enterprise Key Server, the software developer or vendor should treat this as ppRegNotRegistered, since it indicates a potential hacking attempt.

ppRegistered—The end user has purchased the application 202 and a valid registration key is available. This is a case when a key is written to the buffer.

ppRegBadKey—This state is set by the application 202, if the key provided by GetRegState is invalid. In this case, the application 202 is treated as unregistered. The NotifyBadKey parameter provides further details.

ppRegReturned—This state is set by the application 202, if the user has requested and confirmed a refund for the application 202. The application 202 should revert to trial or expired mode.

ppInvalid—The plug-in 204 is not valid. This is the same as Valid( ) ==false.

If the registration state is ppRegPendingTooLong, GetRegState displays an alert informing the end user to perform a HotSync operation as soon as possible. If the software developer or vendor employs the GetRegState function in situations where displaying the user interface would be problematic, such as processing system find launch codes, true is specified for the silent parameter.

void NotifyBadKey( )

If a key is retrieved from the web server 104a, but the key is not valid, an appropriate message should be displayed to the end user and a call to the NotifyBadKey( ) function should be performed. This can happen under the following situations, for example:

The end user has changed their HotSync user name. The web server 104a automatically sends an e-mail to the end user to confirm that they have permanently changed their HotSync user name. If they have, the web server 104a automatically provides new keys for the purchased applications 202. The web server 104a restricts the number of times end users can do this to prevent abuse.

The end user has purchased the application 202 by phone, but has incorrectly entered the code. In this case, the user should still be on the phone with the sales person so they can try again until they succeed in entering a proper code.

Something has gone wrong and the web server 104a has returned an invalid key. When the web server 104a detects this situation, an e-mail can be sent to the end user and the application developer or vendor to attempt to quickly resolve the issue.

void SetExternallRegistered( )

The application 202 can use this function to inform the service that the application 202 has been purchased through some mechanism external to the service. The plug-in will use this information to avoid offering coupons for the application 202, since the user has already purchased the application 202.

void SetExpired( )

The application 202 can use this function to inform the service that the trial period has expired.

void GetPrice(char *buffer)

Retrieves the display-ready price string for the application 202 from the PDA 102b database 208. This may be different from the price specified in the application 202 resources, if a newer price has been retrieved from the web server 104a.

void SetAppData(UInt32 appData) UInt32 GetAppData( )

Applications 202 can store a 32-bit value on the web server 104a. This value can be used to store items, such as number of uses or the date the application 202 was first executed. This is a great way to enhance the software developer or vendor copy protection mechanism.

PPRegState DoPocketPurchase(Uint32 productID, Uint16 days, Uint16 uses, Boolean trackInPocketPurchase, char* buffer, Uint16* size)

Instead of implementing all of the above functions, an application 202 can alternatively use a simplified interface. The DoPocketPurchase function provides a single-call interface to the service. The single call will display nag screens if necessary, allow purchase and retrieve registration codes. This is the preferred interface for those less concerned with security. This single function implements an entire trial and registration mechanism. Returned registration codes are digitally signed and the signature is checked internal to the DoPocketPurchase function, increasing security and greatly simplifying application protection.

Using Digital Signatures as Registration Codes: bool ValidateKey(char* regcode)

The ValidateKey function can be used to validate Rivest-Shamir-Adleman (RSA) digital signatures. To validate the plug-in 204, a plug-in 204 loader does a hash on the plug-in 204 code and then checks the signature using 1024-bit RSA public key encryption. This code is part of the PocketPurchaseClient library that is linked with the application 202. Since the library is linked into the application 202, the service provider digital registration keys can be employed, because, advantageously, digital signatures make excellent registration codes. When the software developer or vendor selects the registration code algorithm, “RSA Signature” can be specified. The key returned by the GetRegState function will then be the end user's HotSync name encrypted with the application's private key. A 256-byte hex buffer can be employed to store this key. Then the ValidateKey function can be employed to verify that the key matches the HotSync name. Creating a key generator is effectively impossible with current technology without the private key, so the private key should be well protected.

A downside to the above approach is that checking a digital signature takes about ⅓ of a second on a 33 MHz device. The signature is checked when the end user first registers the application 202. After the initial check, the signature can be checked periodically to verify that the key is still valid.

Below is an exemplary code snippet that checks approximately 1-in-32 times the application 202 is run:

```
if (prefs.isRegistered && (TimGetSeconds & 0x1f) == 0) {
  char buf[0x101];
  if (pocketPurchase.GetRegState(buf) != ppRegRegistered &&
  !ValidateKey(buf))
    prefs.isRegistered = false;
}
```

A likely question is “What if I don't sell exclusively through the service provider?” In this case, if the end user purchases the application 202 directly from the software vendor's website, the end user cannot be expected to type in a 256-byte hex number. The solution is to send the end user a .pdb file including the key. The end user then installs the .pdb file on their handheld device 102b to register the application 202. This has the added benefit of notifying the service provider that the end user is registered and, thus, eligible for upgrade offers and discounts. To create the key, a KeyGen utility can be downloaded for the application 202 from the web server 104a. The software developer or vendor can also download a Palm OS version of the software developer or vendor key generator so that the software developer or vendor can beam a registration code directly from their handheld. Security is provided because the key generator is locked to the software developer or vendor HotSync user name and device serial number.

Returns can be handled by either the service provider or the software vendor. The service provider or software vendor sends a file to the end user, for example, in the form of a .pdb file, for example. The end user installs that file to their device. The user then runs the application 202. The user will be prompted to confirm the return. If confirmed, the application 202 can be unregistered, returning to an unpurchased trial or expired state. Then, on a next connection to the service provider, for example, via the server 104a, the purchase of the user can be refunded.

In addition, during a HotSync operation, the desktop conduit 210 can be configured to determine expired or unregistered applications and prompt the end user to purchase such applications from the user computer 102a.

Further, CSV e-mails sent out by stores, such as PalmGear, Handango, etc., can be received and converted into a registration .pdb key file that can be sent to the end user. The plug-in 204 can be configured to automatically detect the file, validate the authenticity of the file, and set the state of the user to registered with respect to the corresponding application 202. Advantageously, the DoPocketPurchase function can be configured to automatically enable the corresponding application 202, if such a .pdb file has been installed.

In an exemplary embodiment, the software developer or vendor implementation strategy, for example, can include:

Adding the resources to the application.

Instantiating the PocketPurchasePlugin as a global variable in the StartApplication function.

Using the pocketPurchase->GetRegState( ) function to check the registration state of the application 202 and storing this state in a global for use elsewhere in the application 202. If the state is ppRegRegistered, call GetRegState again to get the key in a buffer. Check to see if the key is valid. If the key is valid, set the application 202 registration state to registered and display a message thanking the end user for regestering. If the key is invalid, do pocketPurchase->NotifyBadKey( ) and do not display a message.

If the state is ppRegPending, store TimGetSeconds( ) in the application 202 preferences. Time should be stored if it has never been stored before. This is a backup of the registration time to prevent tampering. This locally stored time should be passed to the constructor.

If the state is ppRegReturned, unregister the application 202.

When appropriate, call pocketPurchase->Register( ). If true is returned, check GetRegState( ) as when the application 202 starts and handle both the ppRegRegistered and ppRegPending cases.

Modifying the application 202 to run in registered mode if GetRegState( ) returns ppRegPending.

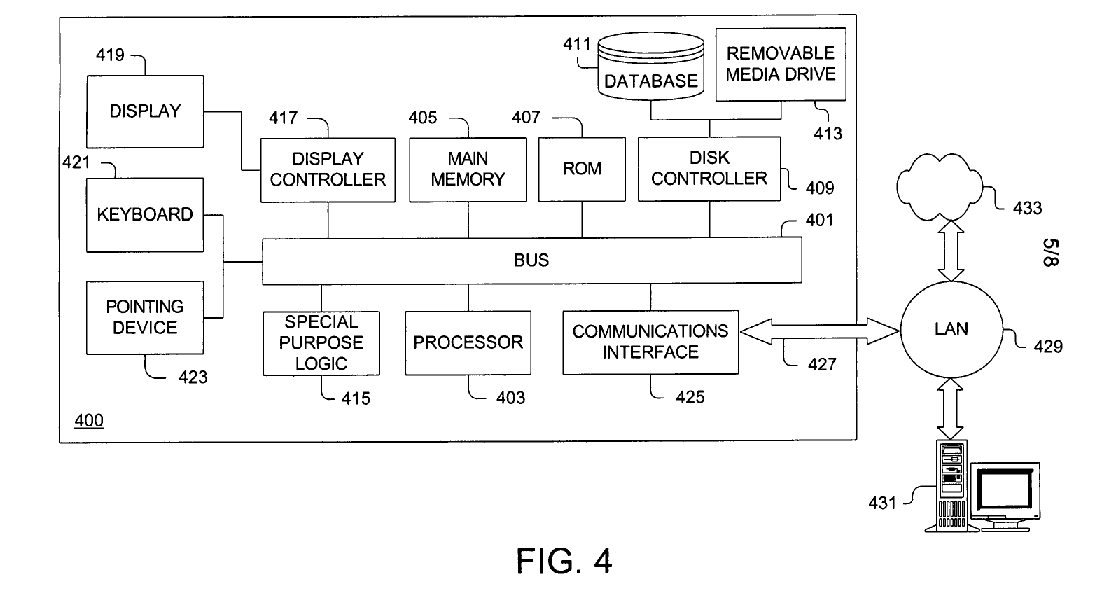

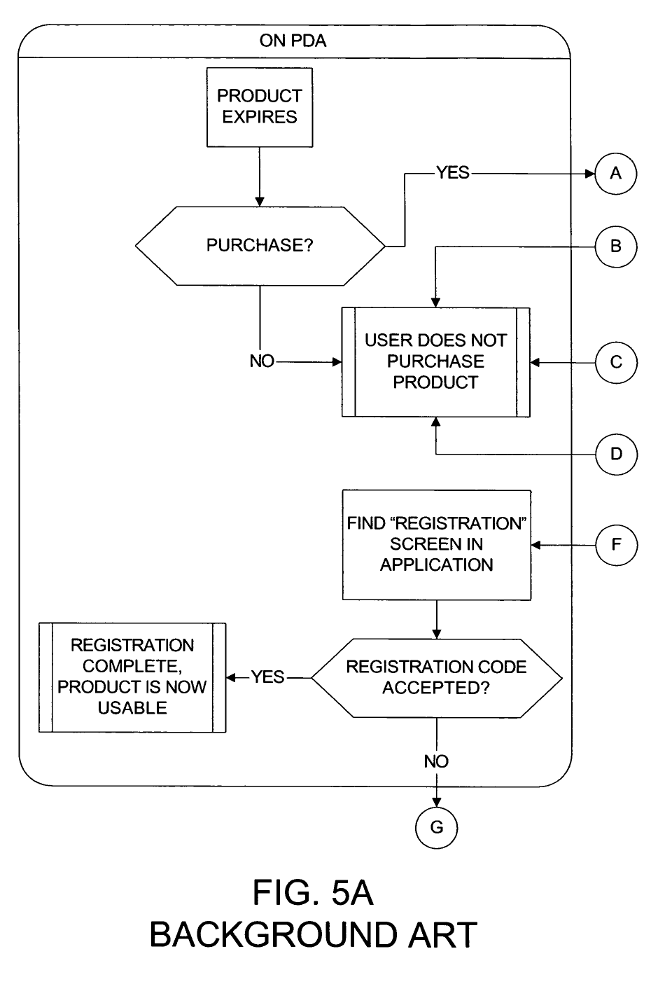

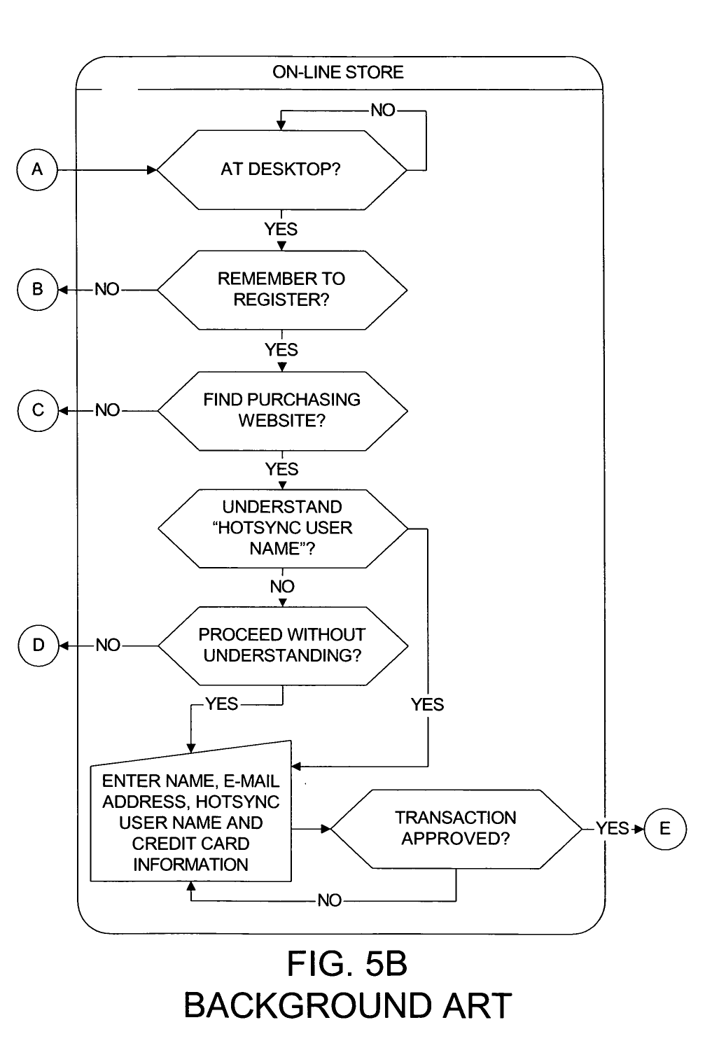

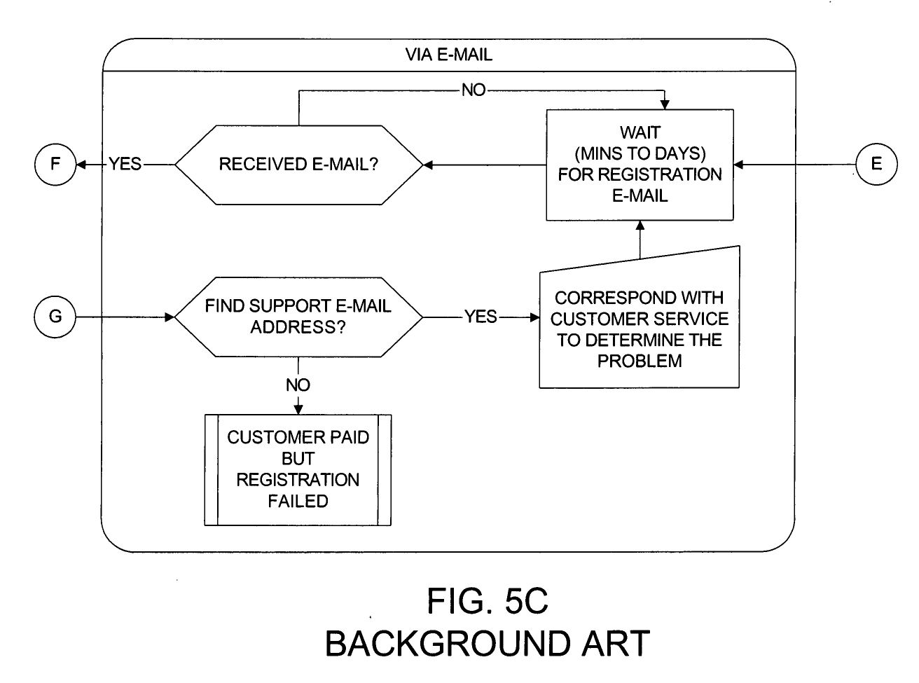

The above-described devices and subsystems of the online software purchase system 100 can include, for example, any suitable servers, workstations, PCs, laptop computers, PDAs, Internet appliances, handheld devices, cellular telephones, wireless devices, other devices, etc., capable of performing the processes of the described embodiments. The devices and subsystems can communicate with each other using any suitable protocol and can be implemented using the computer system 400 of FIG. 4, for example.

One or more interface mechanisms can be used in the system 100 including, for example, Internet access, telecommunications in any form (e.g., voice, modem, etc.), wireless communications media, etc. Accordingly, the communications network 108 employed in the online software purchase system 100 can include, for example, one or more wireless communications networks, cellular communications networks, G3 communications networks, Public Switched Telephone Network (PSTNs), Packet Data Networks (PDNs), the Internet, intranets, and/or combination thereof, etc.

It is to be understood that the online software purchase system 100 is for exemplary purposes, as many variations of the specific hardware used to implement the described embodiments are possible, as will be appreciated by those skilled in the relevant art(s). For example, the functionality of the devices and the subsystems of the online software purchase system 100 can be implemented via one or more programmed computer systems or devices.

To implement such variations as well as other variations, a single computer system (e.g., the computer system 400 of FIG. 4) can be programmed to perform the special purpose functions of one or more of the devices and subsystems of the online software purchase system 100. On the other hand, two or more programmed computer systems or devices can be substituted for any one of the devices and subsystems of the online software purchase system 100. Accordingly, principles and advantages of distributed processing, such as redundancy, replication, etc., also can be implemented, as desired, to increase the robustness and performance of the online software purchase system 100, for example.

The online software purchase system 100 can store information relating to various processes described herein. This information can be stored in one or more memories, such as a hard disk, optical disk, magneto-optical disk, RAM, etc., of the devices of the online software purchase system 100. One or more databases of the devices and subsystems of the online software purchase system 100 can store the information used to implement the embodiments of the present invention. The databases can be organized using data structures (e.g., records, tables, arrays, fields, graphs, trees, and/or lists) included in one or more memories, such as the memories listed above or any of the storage devices listed below in the discussion of FIG. 4, for example.

The previously described processes can include appropriate data structures for storing data collected and/or generated by the processes of the online software purchase system 100 in one or more databases thereof. Such data structures accordingly can include fields for storing such collected and/or generated data. In a database management system, data can be stored in one or more data containers, each container including records, and the data within each record can be organized into one or more fields. In relational database systems, the data containers can be referred to as tables, the records can be referred to as rows, and the fields can be referred to as columns. In object-oriented databases, the data containers can be referred to as object classes, the records can be referred to as objects, and the fields can be referred to as attributes. Other database architectures can be employed and use other terminology. Systems that implement the embodiments of the present invention are not limited to any particular type of data container or database architecture.

All or a portion of the online software purchase system 100 (e.g., as described with respect to FIGS. 1-3) can be conveniently implemented using one or more conventional general purpose computer systems, microprocessors, digital signal processors, micro-controllers, etc., programmed according to the teachings of the embodiments of the present invention (e.g., using the computer system of FIG. 4), as will be appreciated by those skilled in the computer and software art(s). Appropriate software can be readily prepared by programmers of ordinary skill based on the teachings of the present disclosure, as will be appreciated by those skilled in the software art. Further, the system 100 can be implemented on the World Wide Web (e.g., using the computer system of FIG. 4). In addition, the online software purchase system 100 (e.g., as described with respect to FIGS. 1-3) can be implemented by the preparation of application-specific integrated circuits or by interconnecting an appropriate network of conventional component circuits, as will be appreciated by those skilled in the electrical art(s).

FIG. 4 illustrates a computer system 400 upon which the described embodiments (e.g., the devices and subsystems of the online software purchase system 100) can be implemented. The various embodiments can be implemented on a single such computer system, or a collection of multiple such computer systems. The computer system 400 can include a bus 401 or other communication mechanism for communicating information, and a processor 403 coupled to the bus 401 for processing the information. The computer system 400 also can include a main memory 405, such as a random access memory (RAM), other dynamic storage device (e.g., dynamic RAM (DRAM), static RAM (SRAM), synchronous DRAM (SDRAM)), etc., coupled to the bus 401 for storing information and instructions to be executed by the processor 403.

In addition, the main memory 405 also can be used for storing temporary variables or other intermediate information during the execution of.instructions by the processor 403. The computer system 400 further can include a ROM 407 or other static storage device (e.g., programmable ROM (PROM), erasable PROM (EPROM), electrically erasable PROM (EEPROM), etc.) coupled to the bus 401 for storing static information and instructions.

The computer system 400 also can include a disk controller 409 coupled to the bus 401 to control one or more storage devices for storing information and instructions, such as a magnetic hard disk 411, and a removable media drive 413 (e.g., floppy disk drive, read-only compact disc drive, read/write compact disc drive, compact disc jukebox, tape drive, and removable magneto-optical drive). The storage devices can be added to the computer system 400 using an appropriate device interface (e.g., small computer system interface (SCSI), integrated device electronics (IDE), enhanced-IDE (E-IDE), direct memory access (DMA), or ultra-DMA).

The computer system 400 also can include special purpose logic devices 415, such as application specific integrated circuits (ASICs), full custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, communications functions, etc.

The computer system 400 also can include a display controller 417 coupled to the bus 401 to control a display 419, such as a cathode ray tube (CRT), liquid crystal display (LCD), active matrix display, plasma display, touch display, etc., for displaying or conveying information to a computer user. The computer system can include input devices, such as a keyboard 421 including alphanumeric and other keys and a pointing device 423, for interacting with a computer user and providing information to the processor 403. The pointing device 423 can include, for example, a mouse, a trackball, a pointing stick, etc., or voice recognition processor, etc., for communicating direction information and command selections to the processor 403 and for controlling cursor movement on the display 419. In addition, a printer can provide printed listings of the data structures/information of the system shown in FIG. 1, or any other data stored and/or generated by the computer system 400.

The computer system 400 can perform a portion or all of the processing steps of the invention in response to the processor 403 executing one or more sequences of one or more instructions contained in a memory, such as the main memory 405. Such instructions can be read into the main memory 405 from another computer readable medium, such as the hard disk 411 or the removable media drive 413. Execution of the arrangement of instructions contained in the main memory 405 causes the processor 403 to perform the process steps described herein. One or more processors in a multi-processing arrangement also can be employed to execute the sequences of instructions contained in the main memory 405. In alternative embodiments, hard-wired circuitry can be used in place of or in combination with software instructions. Thus, embodiments are not limited to any specific combination of hardware circuitry and/or software.

Stored on any one or on a combination of computer readable media, the embodiments of the present invention can include software for controlling the computer system 400, for driving a device or devices for implementing the invention, and for enabling the computer system 400 to interact with a human user (e.g., users of the online software purchase system 100, etc.). Such software can include, but is not limited to, device drivers, firmware, operating systems, development tools, applications software, etc. Such computer readable media further can include the computer program product of an embodiment of the present invention for performing all or a portion (if processing is distributed) of the processing performed in implementing the invention. Computer code devices of the embodiments of the present invention can include any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the embodiments of the present invention can be distributed for better performance, reliability, and/or cost.

The computer system 400 also can include a communication interface 425 coupled to the bus 401. The communication interface 425 can provide a two-way data communication coupling to a network link 427 that is connected to, for example, a local area network (LAN) 429, or to another communications network 433 (e.g. a wide area network (WAN), a global packet data communication network, such as the Internet, etc.). For example, the communication interface 425 can include a digital subscriber line (DSL) card or modem, an integrated services digital network (ISDN) card, a cable modem, a telephone modem, etc., to provide a data communication connection to a corresponding type of telephone line. As another example, the communication interface 425 can include a local area network (LAN) card (e.g., for Ethernet™, an Asynchronous Transfer Model (ATM) network, etc.), etc., to provide a data communication connection to a compatible LAN. Wireless links can also be implemented. In any such implementation, the communication interface 425 can send and receive electrical, electromagnetic, or optical signals that carry digital data streams representing various types of information. Further, the communication interface 425 can include peripheral interface devices, such as a Universal Serial Bus (USB) interface, a PCMCIA (Personal Computer Memory Card International Association) interface, etc.

The network link 427 typically can provide data communication through one or more networks to other data devices. For example, the network link 427 can provide a connection through the LAN 429 to a host computer 431, which has connectivity to the network 433 or to data equipment operated by a service provider. The LAN 429 and the network 433 both can employ electrical, electromagnetic, or optical signals to convey information and instructions. The signals through the various networks and the signals on the network link 427 and through the communication interface 425, which communicate digital data with computer system 400, are exemplary forms of carrier waves bearing the information and instructions.

The computer system 400 can send messages and receive data, including program code, through the network 429 and/or 433, the network link 427, and the communication interface 425. In the Internet example, a server can transmit requested code belonging to an application program for implementing an embodiment of the present invention through the network 433, the LAN 429 and the communication interface 425. The processor 403 can execute the transmitted code while being received and/or store the code in the storage devices 411 or 413, or other non-volatile storage for later execution. In this manner, computer system 400 can obtain application code in the form of a carrier wave. With the system of FIG. 4, the embodiments of the present invention can be implemented on the Internet as a Web Server 400 performing one or more of the processes according to the embodiments of the present invention for one or more computers coupled to the web server 400 through the network 433 coupled to the network link 427.

The term “computer readable medium” as used herein can refer to any medium that participates in providing instructions to the processor 403 for execution. Such a medium can take many forms, including but not limited to, non-volatile media, volatile media, transmission media, etc. Non-volatile media can include, for example, optical or magnetic disks, magneto-optical disks, etc., such as the hard disk 411 or the removable media drive 413. Volatile media can include dynamic memory, etc., such as the main memory 405. Transmission media can include coaxial cables, copper wire and fiber optics, including the wires that make up the bus 401. Transmission media can also take the form of acoustic, optical, or electromagnetic waves, such as those generated during radio frequency (RF) and infrared (IR) data communications.

As stated above, the computer system 400 can include at least one computer readable medium or memory for holding instructions programmed according to the teachings of the invention and for containing data structures, tables, records, or other data described herein. Common forms of computer-readable media can include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media can be involved in providing instructions to a processor for execution. For example, the instructions for carrying out at least part of the embodiments of the present invention can initially be borne on a magnetic disk of a remote computer connected to either of the networks 429 and 433. In such a scenario, the remote computer can load the instructions into main memory and send the instructions, for example, over a telephone line using a modem. A modem of a local computer system can receive the data on the telephone line and use an infrared transmitter to convert the data to an infrared signal and transmit the infrared signal to a portable computing device, such as a PDA, a laptop, an Internet appliance, etc. An infrared detector on the portable computing device can receive the information and instructions borne by the infrared signal and place the data on a bus. The bus can convey the data to main memory, from which a processor retrieves and executes the instructions. The instructions received by main memory can optionally be stored on storage device either before or after execution by processor.

Advantageously, the described embodiments provide numerous end-user benefits, for example:

Simplified purchasing: The user can purchase software applications while standing in line at the grocery store, while on an airplane, etc.

Key repository: The user does not have to worry about losing software registration keys, because when the user reinstalls software that has already been purchased, the software keys are provided automatically.

Update notification: The user receives a notification of software product updates directly in the purchased software application.

Single point of contact for name or address changes: User information changes are automatically sent to the vendors of purchased software applications.

In addition, advantageously, the described embodiments provide numerous software developer benefits, for example:

Increased sales: The user is much more likely to purchase other software applications if the user can do so simply and at any time.

Automatic key generation: The software vendor can specify their own key generation algorithm or a key generation algorithm builder can be provided that allows specifying of a series of operations to perform on each character of, for example, the user's HotSync user name. Optionally, a provided digital signature system can be used to create even more secure keys.

Correct HotSync user names and other information: Since the HotSync user names and other information are obtained directly from the user's handheld device (e.g., via a HotSync operation, an ActiveX control, etc.), accuracy is assured.

Reduced technical support: Typically, 70-90% of technical support e-mails are software registration code related. Accordingly, the automatic generation and transfer of software registration codes reduces the technical support burden.

Comma Separated Value (CSV) file sent by e-mail for each sale: The CSV file can be used by the vendor to build a contact list. However, since the vendor need not send a software registration key, the vendor can ignore this CSV file because the vendor can request a CSV file for users of any of the products of the vendor.

Ability to generate coupons: Coupons can be displayed directly in the user's software application. This makes it easy for vendors to handle upgrades and/or seasonal discounts.

Optional public key encrypted registration keys: Public key encrypted registration keys make it virtually impossible for a hacker to create a key generator for a vendor's application.

Although the above embodiments of the present invention are described in terms of purchasing of software applications 202 online by handheld devices, such as the end user PDA 102b, the present invention is applicable to purchasing of software applications 202 online by other computing devices, such as laptop computers, personal computes, etc., as will be appreciated by those skilled in the relevant art(s).

Although the above embodiments of the present invention are described in terms of purchasing of software applications 202, the present invention is applicable to purchasing of content, such as digital music, e-books, movies, etc., as will be appreciated by those skilled in the relevant art(s).

Although the above embodiments of the present invention are described in terms of purchasing, the present invention is applicable to renting, leasing, etc., of applications, content, etc., as will be appreciated by those skilled in the relevant art(s).

Although the above embodiments of the present invention are described in terms of the end user PDA 102b plug-in 204 communicating with the web server 104a via the client 206 of the end user PC 102a, the present invention includes the plug-in 204 configured to enable a client on the end user PDA 102b to communicate directly with the web server 104a over the communications network 108 (e.g., via modem, wireless modem, DSL modem, cable modem, etc.) to receive updates and other information, download software, etc., as will be appreciated by those skilled in the relevant art(s).

Although the above embodiments of the present invention are described in terms of the end user PDA 102b plug-in 204 communicating with the web server 104a via the client 206 of the end user PC 102a, the present invention includes other interface mechanisms, such as library, source code, etc., directly added into an application 202, as will be appreciated by those skilled in the relevant art(s).

Although the above embodiments of the present invention are described in terms of the end user information, such as the end user HotSync user name, etc., being automatically retrieved from the end user PDA 102b via the desktop conduit 210 and client 206, the present invention includes such information being automatically retrieved using other mechanisms, such as web page applets (e.g., ActiveX controls, etc.), for example, when the end user connects to the web server 104a, as will be appreciated by those skilled in the relevant art(s).

While the present invention has been described in connection with a number of embodiments and implementations, the present invention is not so limited but rather covers various modifications and equivalent arrangements, which fall within the purview of the appended claims.

What is claimed is:

1. A method for purchasing software online, comprising:
enabling a software purchase transaction for a computing device, while the computing device is offline; and
completing the software purchase transaction, when the computing device goes online.

2. The method of claim 1, comprising:
correcting mis-entered information relating to the software purchase for the computing device, while the computing device is offline; and
communicating one of software updates, price updates, software upgrades, and purchasing incentives, when the computing device goes online.

3. The method of claim 1, comprising:
providing a software distributor relationship between a vendor and a software distributor of the software; and
enabling revenue distribution between the vendor and the software distributor for the software purchased on the computing device.

4. The method of claim 3, comprising:
adding a resource to the software purchased on the computing device for specifying the revenue distribution between the vendor and the software distributor.

5. The method of claim 1, comprising:
providing a software development tool provider relationship between a vendor and a software development tool provider; and
enabling revenue distribution between the vendor and the software development tool provider for a software development tool used in the creation of the software purchased on the computing device.

6. The method of claim 5, comprising:
adding a resource to the software purchased on the computing device for specifying the revenue distribution between the vendor and the software development tool provider.

7. The method of claim 1, comprising:
providing a software affiliate relationship between a vendor and a software affiliate; and
enabling revenue distribution between an online software purchase service provider and the software affiliate for affiliate software purchased on the computing device.

8. The method of claim 7, comprising:
adding a resource to the software purchased on the computing device for specifying the revenue distribution between the vendor and the software affiliate.

9. The method of claim 1, comprising:
providing one of a coupon, up-selling, and special offer mechanism for the software purchased on the computing device; and
distributing a coupon based on the mechanism to the computing device.

10. The method of claim 9, comprising:
displaying the coupon when accessing the software on the computing device.

11. The method of claim 1, comprising:
developing the software for purchase on the computing device; and
distributing the developed software to the computing device.

12. The method of claim 1, comprising:
providing an interface for application programming in software for purchase of the application on the computing device from within the application; and
distributing the software to the computing device.

13. The method of claim 1, comprising:
purchasing the software for the computing device, while the computing device is offline; and
accessing information for completing the purchase from the computing device when the computing device goes online.

14. The method of claim 13, comprising:
not storing the purchasing information external to the computing device.

15. The method of claim 1, comprising:
storing a software registration key for the software purchased for the computing device; and
distributing the stored software registration key to the computing device online.

16. The method of claim 1, comprising:
prompting a user of the software to confirm a refund request from within the software; and
disabling the software before sending a refund authorization to a service provider of the software.

17. The method of claim 1, comprising:
confirming a return of the purchased software; and
deactivating the software, if the return is confirmed by a user of the software.

18. The method of claim 1, comprising:
providing a site license for the software purchased for the computing device; and
distributing the site license to the computing device.

19. The method of claim 18, comprising:
configuring the site license as a generic license for the software purchased for the computing device; and
converting the generic license to a device specific license for the computing device.

20. The method of claim 1, comprising:
embedding a mechanism within the software on the computing device for enabling the purchasing of the software on the computing device.

21. The method of claim 1, wherein the computing device comprises a handheld device.

22. The method of claim 21, wherein the handheld device includes a Palm Operating System (Palm OS).

23. A system for purchasing software online, comprising:
means for enabling a software purchase transaction for a computing device, while the computing device is offline; and
means for completing the software purchase transaction, when the computing device goes online.

24. The system of claim 23, comprising:
means for embedding a mechanism within the software on the computing device for enabling the purchasing of the software on the computing device.

25. The system of claim 23, wherein the computing device comprises a handheld device.

26. The system of claim 23, wherein the handheld device includes a Palm Operating System (Palm OS).

27. The system of claim 23, wherein the means for enabling and the means for completing comprise devices of a computer system.

28. The system of claim 23, wherein the means for enabling and the means for completing comprise computer-readable instructions stored on a computer readable medium.

29. A method for purchasing software online, comprising:
providing a site license for software purchased for a computing device, wherein the site license is configured as a generic license for the software purchased for the computing device;
converting the generic license to a device specific license for the computing device; and
distributing the device specific license to the computing device.

30. The method of claim 29, comprising:
embedding a mechanism within the software on the computing device for enabling the purchasing of the software on the computing device.

31. The method of claim 29, wherein the computing device comprises a handheld device.

32. The method of claim 29, wherein the handheld device includes a Palm Operating System (Palm OS).

33. A system for purchasing software online, comprising:
means for providing a site license for software purchased for a computing device, wherein the site license is configured as a generic license for the software purchased for the computing device;
means converting the generic license to a device specific license for the computing device; and
means distributing the device specific license to the computing device.

34. The system of claim 33, comprising:
means for embedding a mechanism within the software on the computing device for enabling the purchasing of the software on the computing device.

35. The system of claim 33, wherein the computing device comprises a handheld device.

36. The system of claim 33, wherein the handheld device includes a Palm Operating System (Palm OS).

37. The system of claim 33, wherein the means for providing, the means for converting, and means for distributing comprise devices of a computer system.

38. The system of claim 33, wherein the means for providing, the means for converting, and means for distributing comprise computer-readable instructions stored on a computer readable medium.
